(19) United States
(12) Patent Application Publication
(10) Pub. No.: US 2023/0094361 A1
(43) Pub. Date: Mar. 30, 2023

(54) VOICE PROCESSING APPARATUS

(71) Applicant: KYOCERA Document Solutions Inc., Osaka (JP)

(72) Inventor: Shinichi Kawaguchi, Osaka (JP)

(21) Appl. No.: 17/936,310

(22) Filed: Sep. 28, 2022

(30) Foreign Application Priority Data
Sep. 29, 2021 (JP) 2021-159226

(51) Int. Cl. G10L 21/0232; G10L 17/04; G10L 17/02

(52) U.S. Cl. CPC G10L 21/0232; G10L 17/04; G10L 17/02

(57) ABSTRACT

A voice processing apparatus includes a reception portion, a production portion and a transmission portion. The reception portion receives sound signals. The production portion produces voice data corresponding to a voice of a speaker through extraction of information of a specific frequency band from the sound signals or through removal of information of a frequency band other than the frequency band of the specific frequency band from the sound signals. The transmission portion transmits the voice data.

### INCORPORATION BY REFERENCE

This application is based upon and claims the benefit of priority from the corresponding Japanese Patent Application No. 2021-159226 filed on Sep. 29, 2021, the entire contents of which are incorporated herein by reference.

### BACKGROUND

The present disclosure relates to a voice processing apparatus.

A system to remove external noise from the voice inputted through a speakers' microphone is known.

### SUMMARY

A voice processing apparatus according to the present disclosure includes a reception portion, a generation portion and a transmission portion. The reception portion receives voice information. The production portion processes sound information of a specific frequency band to produce a processed voice of a speaker only. The transmission portion transmits the processed voice.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows the configuration of a voice processing system including a voice processing apparatus according to a first embodiment of the present disclosure.

FIG. 2 is a block diagram showing the configuration of the voice processing apparatus according the first embodiment.

FIG. 3 is a flowchart showing one example of the information processing by the voice processing apparatus according to the first embodiment.

FIG. 4 is a block diagram showing the configuration of a voice processing apparatus according to a second embodiment.

FIG. 5 is a flowchart showing one example of the information processing by the voice processing apparatus according to the second embodiment.

### DETAILED DESCRIPTION

Embodiments of the present disclosure will be described below with reference to the drawings. In the drawings, the same or corresponding elements are denoted by the same reference numerals and the descriptions thereof are omitted.

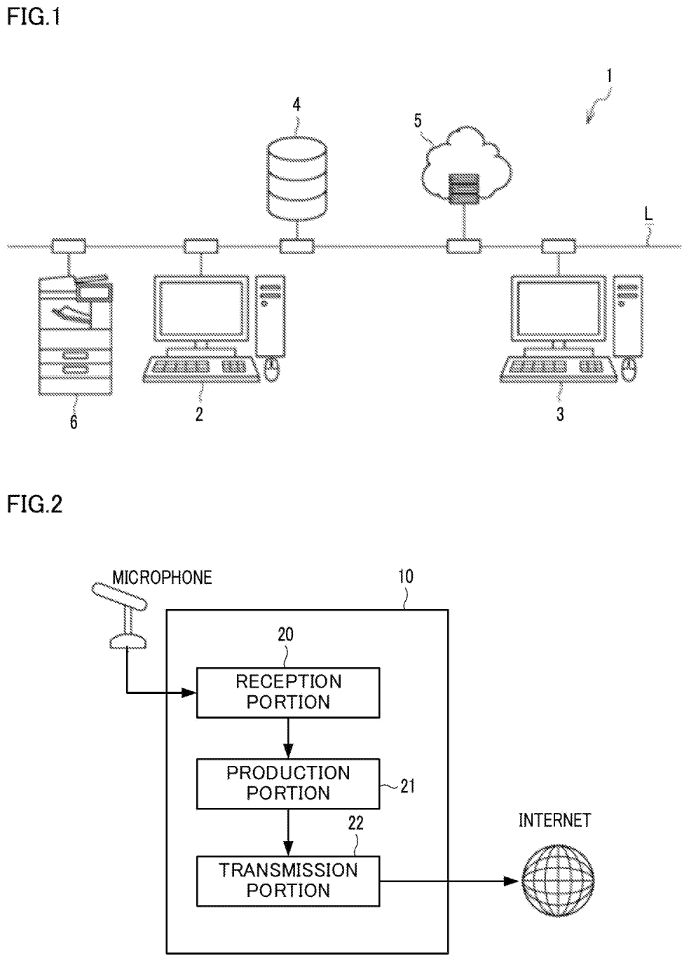

First, a voice processing system 1 will be described with reference to FIG. 1.

As shown in FIG. 1, the voice processing system 1 includes, as one example, a PC (personal computer) terminal 2, a PC terminal 3, a server 4, a cloud 5, and a multifunction peripheral 6.

The PC terminal 2, PC terminal 3, server 4, cloud 5 and multifunction peripheral 6 are connected together with a line L.

The line L includes a LAN (local area network), WAN (wide area network) and internet, for example.

The voice processing apparatus 10 according to a first embodiment may be disposed in any of the PC terminal 2, PC terminal 3, server 4 and cloud 5.

### First Embodiment: the Configuration of a Voice Processing Apparatus 19

Next, the voice processing apparatus 10 according to the first embodiment will be described with reference to FIG. 1 and FIG. 2. The first embodiment can be applied to other embodiments.

The voice processing apparatus 10 includes a reception portion 20, a generation portion 21, and a transmission portion 22 (see FIG. 2). The generation portion 21 and transmission portion 22 each can be realized by an ASIC (application specific integrated circuit), for example.

As shown in FIG. 2, a microphone receives sound signals and the reception portion 20 receives the sound signals that the microphone has received. The reception portion 20 can be achieved by a CODEC (coder/decoder), for example.

The production portion 21 extracts sound information of a specific frequency band in the sound signals to generate voice data that indicates the voice of the speaker.

The sound signals are analog signals received by the microphone.

The production portion 21 inputs the analog sound signals and outputs the digital voice data.

The specific frequency band is a frequency band of a voice of a specific user, or the speaker. The production portion 21 may include an ND conversion portion and a filter, for example. The ND conversion portion applies an ND conversion to the sound signals to produce sound data. The sound data is the data indicating the sound signals. From the voice data, the filter extracts the data of the specific band as the voice data.

From the sound data received, the filter of the production portion 21 may remove signals of frequency band other than the specific frequency band to extract the voice data.

The transmission portion 22 transmits the voice data. The transmission portion 22 can be realized by a CODEC, for example.

According to the first embodiment, the voice data of the specific frequency band is extracted and transmitted. Thus, voice data of people other than the speaker is not transmitted and only the voice data of the speaker is transmitted.

The filter of the production portion 21 extracts only the voice data of the specific frequency band from the sound data, for example. Contrary, the filter of the production portion 21 may remove information of frequency band other than the specific frequency band from the sound data to extract the voice data.

The transmission portion 22 transmits the voice data of the specific frequency band, which is produced in the production portion 21, to the line L.

The voice data of the specific frequency band is extracted using the filter, for example. In this case, with use of general-purpose device, transmission of voice data of people other than the speaker is restrained. Accordingly, only the voice data of the speaker is transmitted.

From the sound data, information of frequency band other than the specific frequency band may be removed by the filter. The frequency band, to be removed, other than the specific frequency band may be 1,000 Hz to 2,000 Hz.

Generally, the frequency of 1,000 Hz to 2,000 Hz is a voice of human children.

The filter of the production portion 21 may remove information of 1,000 Hz to 2,000 Hz from the sound data to extract the voice data that corresponds to the speaker.

In the above case, the voice signals in the frequency band of 1,000 Hz to 2,000 Hz, which is generated by children, is removed from the sound data. Accordingly, the information of the voice of children living with an at-home worker is removed properly.

The specific frequency band may be 125 Hz to 500 Hz. Generally, the frequency of 125Hz to 500 Hz is a voice of human adults.

The filter of the production portion 21 extracts information of 125 Hz to 500 Hz from the sound data to produce the voice data that corresponds to the speaker, for example. Contrary to this, the filter of the production portion 21 may remove information of frequency band other than the frequency band of 125 Hz to 500 Hz from the sound data to produce the voice data that corresponds to the speaker.

According to the embodiment described above, only the voice data of the frequency band of 125 Hz to 500 Hz, which is produced by adults, is transmitted. As a result, only the voice data of an at-home worker is transmitted properly.

The specific frequency band may be 125 Hz to 250 Hz. Generally, the frequency of 125 Hz to 250 Hz is a voice of men of human adults.

For example, the filter of the production portion 21 extracts information of 125 Hz to 250 Hz from the sound data to produce the voice that corresponds to the speaker. Contrary, the filter of the production portion 21 may remove information of frequency band other than the frequency band of 125 Hz to 250 Hz from the sound data to produce the voice data that corresponds to the speaker.

According to the embodiment described above, only the voice data of the frequency band of 125 Hz to 250 Hz, which is produced by men of human adults, is transmitted. Accordingly, only the voice of a man of at-home worker is transmitted properly.

The specific frequency band may be 250 Hz to 500 Hz. Generally, the frequency of 250 Hz to 500 Hz is a voice of women of human adults.

For example, the filter of the production portion 21 extracts information of 250 Hz to 500 Hz from the sound data to produce the voice that corresponds to the speaker. Contrary to this, the filter of the production portion 21 may remove information of frequency band other than the frequency band of 250 Hz to 500 Hz from the sound data to produce the voice data that corresponds to the speaker.

According to the embodiment described above, only the voice data of the frequency band of 250 Hz to 500 Hz, which is produced by women of human adults, is transmitted. As a result, only the voice of a woman of at-home worker is transmitted properly.

### Second Embodiment: the Configuration of a Voice Processing Apparatus 10A

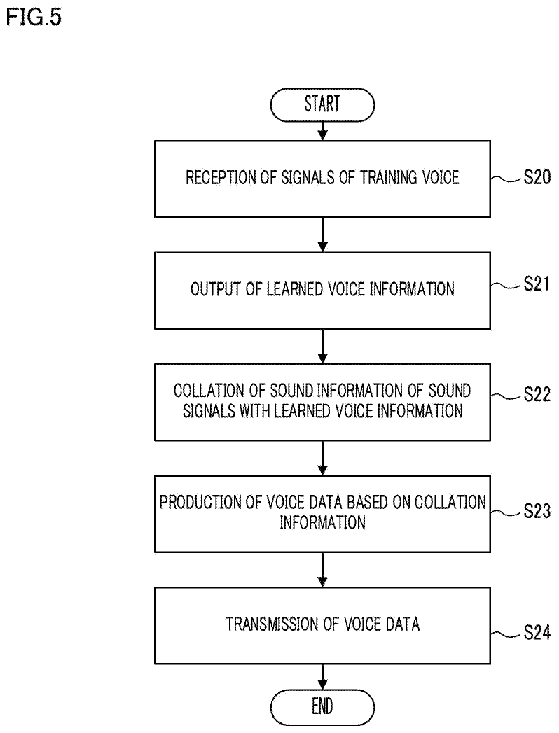

Next, a voice processing apparatus 10A according a second embodiment will be described with reference to FIG. 4.

The voice processing apparatus 10A further includes a voice learning portion 23, a storage portion 24 and a collation portion 25, in addition to the configuration of the voice processing apparatus 10. The voice learning portion 23 and the collation portion 25 each can be realized by an ASIC, for example.

In the voice processing apparatus 10A, the reception portion 20 can receive a plurality of signals of training voices of target speakers through a microphone. The plurality of training voices are multiple sample voices generated by the target speakers.

The voice learning portion 23 performs a voice learning process based on the signals of the plurality of training voices to output learned voice information that correspond to the target speakers. The voice learning processing is a supervised learning process, for example. The supervised learning process uses the plurality of sample voice data, which is generated by the target speakers, and responses corresponding to the data in order to learn parameters of models. After learning, the models reasonably predict responses to new voice data.

The storage portion 24 correlates speaker information identifying the target speakers with the learned voice information for storage. The storage portion 24 is composed of a RAM (random access memory) or ROM (read only memory), for example.

The collation portion 25 collates input voice information, which is voice information included in the sound signals received by the reception portion 20, with the learned voice information to output collation information.

The collation portion 25 outputs collation information of matching when the input voice information matches with any of the learned voice information. The collation portion 25 outputs collation information of unmatching when the input voice information does not match with any of the learned voice information.

The filter of the production portion 21 of the voice processing apparatus 10A extracts the voice data of frequency band of 125 Hz to 500 Hz, which is generated by human adult, based on the collation information and outputs it.

The filter of the production portion 21 of the voice processing apparatus 10A may extract the voice data of frequency band of 125 Hz to 250 Hz, which is generated by men of human adult, based on the collation information, and output it.

The filter of the production portion 21 of the voice processing apparatus 10A may extract the voice data of frequency band of 250 Hz to 500 Hz, which is generated by women of human adult, based on the collation information, and output it.

According to the second embodiment, the voice data of the specific frequency band is transmitted. Thus, only the voice data of a speaker of at-home worker is transmitted, while transmission of voice data of others is restrained.

### First Embodiment: Information Processing

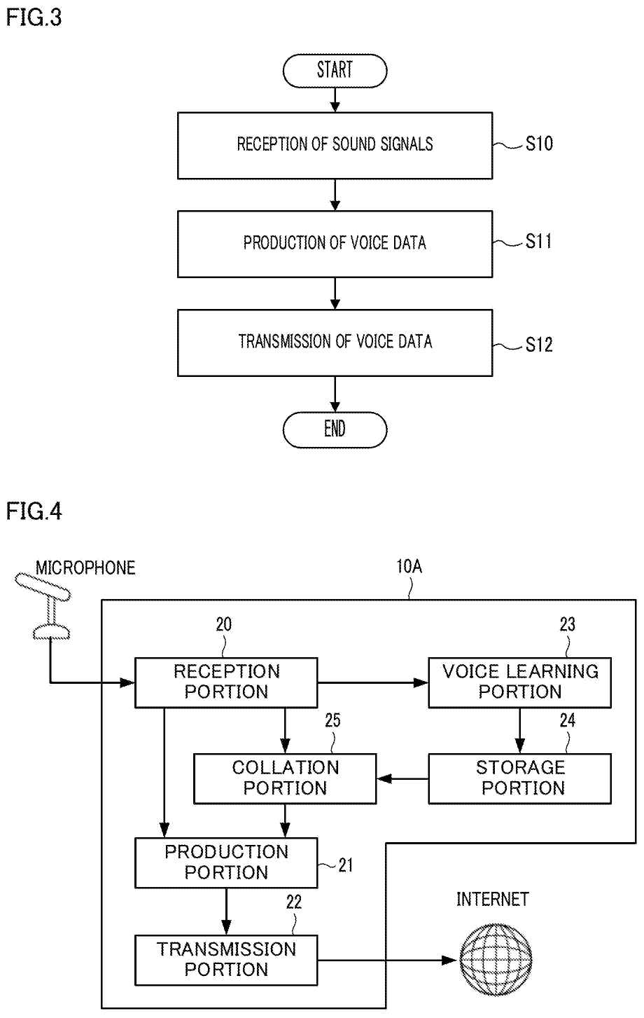

Next, information processing by the voice processing apparatus 10 according to the first embodiment will be described with reference to FIG. 3. FIG. 3 is a flowchart showing an example of information processing by the voice processing apparatus 10 of the first embodiment.

As shown in FIG. 3, the flowchart includes step S10 to step S12. The details are as follows.

In the step S10, the reception portion 20 receives sound signals that the microphone has caught. Then, the processing moves to step S11.

In the step S11, the production portion 21 applies an A/D conversion to the sound signals to produce sound data. Then, the production portion 21 extracts information of a specific frequency band from the sound data to produce voice data that corresponds only to the voice of a speaker. The processing moves to step S12.

In the step S12, the transmission portion 22 transmits the voice data. The processing then ends.

### Second Embodiment: Information Processing

With reference to FIG. 5, information processing of the voice processing apparatus 10A of the second embodiment will be described. FIG. 5 is a flowchart showing an example of information processing of the voice processing apparatus according to the second embodiment.

As shown in FIG. 5, the flowchart includes step S20 to step S24. The details are specified as follows.

In the step S20, the reception portion 20 receives the signals of a plurality of training voices of target speakers through a microphone. Then, the processing moves to step S21.

In the step S21, the voice learning portion 23 performs voice learning processing based on the signals of the plurality of training voices to output learned voice information that corresponds to the target speakers. The processing moves to step S22 when the reception portion 20 receives new sound signals through the microphone.

In the step S22, the collation portion 25 collates input voice information included in the sound signals, which is received by the reception portion 20, with the learned voice information. The processing then moves to step S23.

In the step S23, the production portion 21 applies an ND conversion to the sound signals to produce sound data. Then, the production portion 21 extracts voice data of a specific frequency band from the sound data to produce voice data that corresponds only to the voice of a speaker. The processing further moves to step S24

In the step S24, the transmission portion transmits the voice data. Then, the processing ends.

The embodiments of the present disclosure have been described with reference to the drawings. It should be noted that the present disclosure is not limited to the embodiments described above and it can be implemented in various modes without departing from the gist of the disclosure. For the purpose of easy understanding, each subject component in the drawings may intentionally be illustrated in a schematic manner. For convenience of drawing, the number of each component illustrated in the drawings may be different from the actual number. Furthermore, each component disclosed in the embodiments is merely an example and should not in any way be construed as limitative. It can be modified into various modes without departing from the effects of the present disclosure.

The present disclosure can be utilized in the field of a voice processing apparatus.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A voice processing apparatus comprising:
a reception portion that receives sound signals;
a production portion that produces voice data corresponding to a voice of a speaker through extraction of information of a specific frequency band from the sound signals or through removal of information of a frequency band other than the frequency band of the specific frequency band from the sound signals; and
a transmission portion that transmits the voice data.

2. The voice processing apparatus of claim 1, wherein the production portion includes a filter that extracts information of the specific frequency band from data of the sound signals or that removes information of frequency band other than the specific frequency band from the data of the sound signals, the filter of the production portion producing the voice data.

3. The voice processing apparatus of claim 2, wherein the frequency band other than the specific frequency band is 1,000 Hz to 2,000 Hz, and
wherein the filter produces the voice data through removal of the information of the frequency band other than the specific frequency band from the data of the sound signals.

4. The voice processing apparatus of claim 2,
wherein the specific frequency band is 125 Hz to 500 Hz, and
wherein the filter produces the voice data through extraction of the information of the specific frequency band from the data of the sound signals or through removal of the information of the frequency band other than the specific frequency band from the data of the sound signals.

5. The voice processing apparatus of claim 2,
wherein the specific frequency band is 125 Hz to 250 Hz, and
wherein the filter produces the voice data through extraction of the information of the specific frequency band from the data of the sound signals or through removal of the information of the frequency band other than the specific frequency band from the data of the sound signals.

6. The voice processing apparatus of claim 2,
wherein the specific frequency band is 250 Hz to 500 Hz, and
wherein the filter produces the voice data through extraction of the information of the specific frequency band from the data of the sound signals.

7. The voice processing apparatus of claim 1, the apparatus further comprising:
a voice learning portion that performs voice learning processing based on signals of a plurality of training voices of target speakers to output learned voice information corresponding to the target speakers, the training voices being received by the reception portion;
a storage portion that correlates identification information of the target speakers with the learned voice information for storage; and
a collation portion that collates the sound signals received by the reception portion with the learned voice information to show a collation result,
wherein the production portion produces the voice data through extraction of the information of the specific frequency band from the sound signals based on the collation information or through removal of the information of the frequency band other than the specific frequency band from the sound signals based on the collation information.
